(19) United States
(12) Patent Application Publication
(10) Pub. No.: US 2010/0130230 A1
(43) Pub. Date: May 27, 2010

(54) BEACON SECTORING FOR POSITION DETERMINATION

(75) Inventors: Alok Aggarwal, Foster City, CA (US); Ayman Fawzy Naguib, Cupertino, CA (US); Vinay Sridhara, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/622,369

(22) Filed: Nov. 19, 2009

Related U.S. Application Data
(60) Provisional application No. 61/116,999, filed on Nov. 21, 2008.

(51) Int. Cl. H04W 24/00

(52) U.S. Cl. 455/456.1

(57) ABSTRACT

Apparatuses and methods for sector-based position determination of a mobile station are presented. One method includes determining an estimate of a distance between the mobile station and at least one wireless access point (WAP), receiving sector information which describes sectors associated with the at least one WAP, and combining the distance estimate and sector information to determine a position of the mobile station. One apparatus includes a wireless transceiver, a processor coupled to the wireless transceiver, and a memory coupled to the processor which stores executable instructions and data. The instructions cause the processor to determine an estimate of a distance between the mobile station and at least one wireless access point (WAP), receive sector information which describes sectors associated with the at least one WAP, and combine the distance estimate and sector information to determine a position of the mobile station.

### CLAIM OF PRIORITY UNDER 35 U.S.C. §119

The present application for patent claims priority to Provisional Application No. 61/116,999 entitled “Beacon Sectoring for Position Determination” filed Nov. 21, 2008, and assigned to the assignee hereof and hereby expressly incorporated by reference herein.

### REFERENCE TO CO-PENDING APPLICATIONS FOR PATENT

The present application for patent is related to the following co-pending U.S. patent applications:
“WIRELESS POSITION DETERMINATION USING ADJUSTED ROUND TRIP TIME MEASUREMENTS” by Aggarwal et al., having Attorney Docket No. 090334, filed concurrently herewith, assigned to the assignee hereof, and expressly incorporated by reference herein.
“NETWORK-CENTRIC DETERMINATION OF NODE PROCESSING DELAY” by Aggarwal et al., having Attorney Docket No. 090505, filed concurrently herewith, assigned to the assignee hereof, and expressly incorporated by reference herein.
“WIRELESS-BASED POSITIONING ADJUSTMENTS USING A MOTION SENSOR” by Aggarwal et al., having Attorney Docket No. 090533, filed concurrently herewith, assigned to the assignee hereof, and expressly incorporated by reference herein.

### FIELD OF DISCLOSURE

Aspects of this disclosure generally relate to wireless communication systems, and more specifically, to the use of sectoring for position determination.

### BACKGROUND

Mobile communications networks are in the process of offering increasingly sophisticated capabilities associated with the motion and/or position location sensing of a mobile device. New software applications, such as, for example, those related to personal productivity, collaborative communications, social networking, and/or data acquisition, may utilize motion and/or position sensors to provide new features and services to consumers. Moreover, some regulatory requirements of various jurisdictions may require a network operator to report the location of a mobile device when the mobile device places a call to an emergency service, such as a 911 call in the United States.

In conventional digital cellular networks, position location capability can be provided by Advanced Forward Link Trilateration (AFLT). AFLT may compute the position of a wireless device from the wireless device's measured time of arrival of radio signals transmitted from a plurality of base stations. Improvements to AFLT have been realized by utilizing hybrid position location techniques, where the mobile station may employ a Satellite Positioning System (SPS) receiver. The SPS receiver may provide position information independent of the information derived from the signals transmitted by the base stations. Moreover, position accuracy can be improved by combining measurements derived from both SPS and AFLT systems using conventional techniques. Additionally, with the increased proliferation of micro electro-mechanical systems (MEMS), small, on-board sensors may be used to provide additional relative position, velocity, acceleration and/or orientation information.

Unfortunately, position location techniques based upon signals provided by SPS and/or cellular base stations may encounter difficulties when the mobile device is operating within a building and/or within urban environments. In such situations, multipath and/or degraded signal strength can significantly reduce position accuracy, and can slow the “time-to-fix” to unacceptably long time periods. These shortcomings may be overcome by the mobile device by exploiting received signals from existing wireless data networks, such as Wi-Fi (e.g., Institute of Electrical and Electronics Engineers (IEEE) 802.11x standards), to derive position information.

Utilizing signals from existing wireless data networks to accurately determine the position of a mobile device may involve knowledge of precise time delays incurred by the wireless signals. Such delays may be spatially variant due to, for example, multipath and/or signal interference. Moreover, such delays may change over time based upon the type of network device and/or the network device's current networking load.

However, existing wireless data networks and users of the wireless data networks may be vulnerable to position determination errors. Position determination errors may occur in the presence of noise and/or when a limited number of data points are provided (e.g., not enough access points to triangulate position). Thus, a need exists for a more robust position determination approaches.

### SUMMARY

Exemplary embodiments of the invention are directed to apparatus and methods for sector-based position determination of a mobile station.

In one embodiment, a method of determining a position of a mobile station based upon sectors is provided. The method may include determining an estimate of a distance between the mobile station and at least one wireless access point (WAP), and receiving sector information which describes sectors associated with the WAP. The method may further include combining the distance estimate and sector information to determine a position of the mobile station.

In another embodiment, an apparatus for sector-based position determination of a mobile station is provided. The apparatus may include a wireless transceiver, a processor coupled to the wireless transceiver, and a memory coupled to the processor. The memory may store executable instructions and data for causing the processor to determine an estimate of a distance between the mobile station and at least one wireless access point. The instructions may further cause the processor to receive sector information which describes sectors associated with the WAP, and combine the distance estimate and sector information to determine a position of the mobile station.

Various embodiments presented herein may have the advantages of improving the position location accuracy of a mobile station in the presence of noise, and better determining the mobile station's position when there are not enough WAPs for conventional position determination techniques.

### BRIEF DESCRIPTION OF THE DRAWINGS

The accompanying drawings are presented to aid in the description of embodiments of the invention and are provided solely for illustration of the embodiments and not limitation thereof.

FIG. 1 is a diagram of an exemplary operating environment for a mobile station.

FIG. 2 is a block diagram illustrating various components of an exemplary mobile station.

FIG. 3 is a diagram illustrating an exemplary positioning technique using Local Area Network Wireless Access Points (LAN-WAPs) communicating with a mobile station.

FIG. 4 a diagram illustrating an exemplary scenario where a positioning ambiguity may occur when using two LAN-WAPs to determine the position of a mobile station.

FIG. 5 is a drawing illustrating an exemplary sector-directed position determination technique having four sectors.

FIG. 6 is a flowchart illustrating an exemplary sector-directed position determination algorithm.

FIGS. 7A & 7B are drawings illustrating exemplary scenarios using sector-directed position determination of a mobile station.

### DETAILED DESCRIPTION

Aspects of the embodiments are disclosed in the following description and related drawings. Additionally, well-known elements of the embodiments will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various embodiments may be realized in a number of different forms, all of which have been contemplated to be within the scope of the claimed subject matter. In addition, for each of the embodiments described herein, the corresponding form of any such embodiments may be described herein as, for example, “logic configured to” perform the described action.

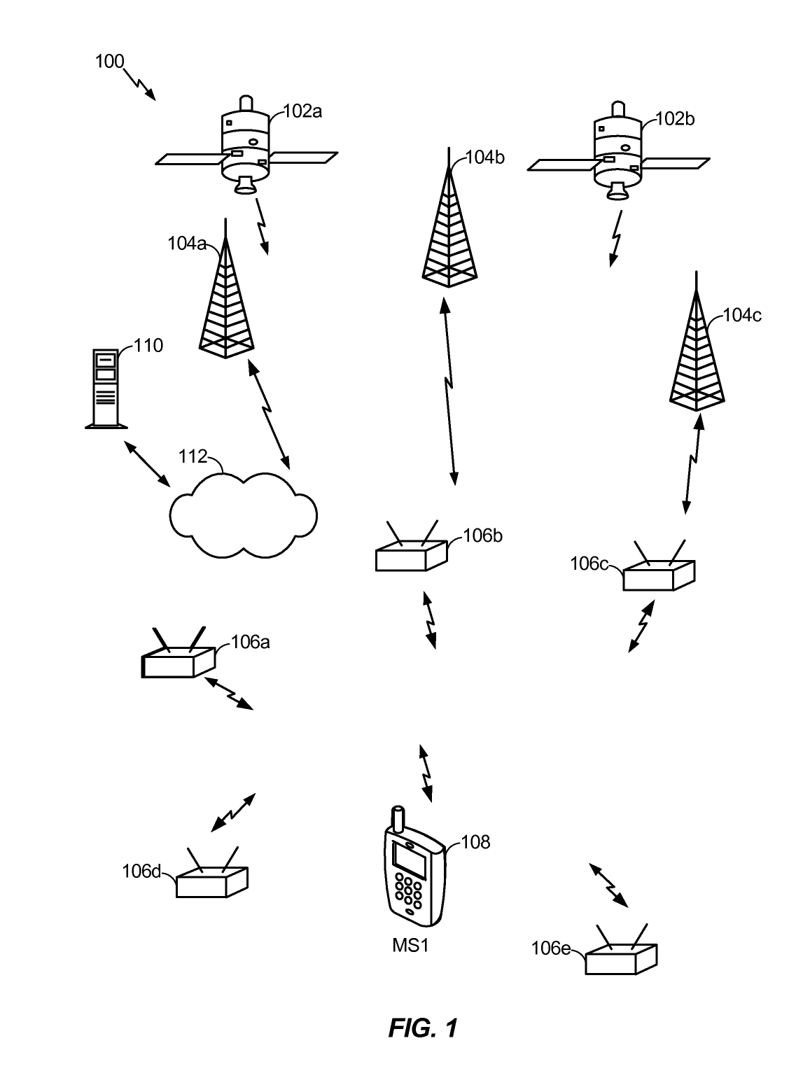

FIG. 1 is a diagram illustrating an exemplary operating environment 100 for a mobile station 108. The operating environment 100 may contain one or more different types of wireless communication systems and/or wireless positioning systems. In the embodiment shown in FIG. 1, a Satellite Positioning System (SPS) 102 may be used as an independent source of position information for the mobile station 108. The mobile station 108 may include one or more dedicated SPS receivers specifically designed to receive signals for deriving geo-location information from the SPS satellites.

The operating environment 100 may also include a plurality of one or more type Wide Area Network Wireless Access Points (WAN-WAPs) 104, which may be used for wireless voice and/or data communication, and as another source of independent position information for mobile station 108. The WAN WAPs 104 may be parts of wireless wide area network (WWAN), which may include cellular base stations at known locations, and/or other wide area wireless systems, such as, for example, WiMAX (e.g., 802.16). The WWAN may include other known network components which are not shown in FIG. 1 for simplicity. Typically, each WAN-WAPs 104a-104c within the WWAN may operate from fixed positions, and provide network coverage over large metropolitan and/or regional areas.

The operating environment 100 may further include Local Area Network Wireless Access Points (LAN-WAPs) 106, and may be used for wireless voice and/or data communication, as well as another independent source of position data. The LAN-WAPs can be part of a Wireless Local Area Network (WLAN), which may operate in buildings and perform communications over smaller geographic regions than a WWAN. Such LAN-WAPs 106 may be part of, for example, Wi-Fi networks (IEEE 802.11x), Bluetooth Networks, a femtocell, etc.

The mobile station 108 may derive position information from any one or a combination of the SPS satellites 102, the WAN-WAPs 104, and/or the LAN-WAPs 106. Each of the aforementioned systems can provide an independent estimate of the position for mobile station 108 using different techniques. In some embodiments, the mobile station may combine the solutions derived from each of the different types of access points (e.g., Wi-Fi access points, femtocells, etc.) to improve the accuracy of the position data. When deriving position data using the SPS 102, the mobile station 108 may utilize a receiver specifically designed for use with the SPS that extracts position, using conventional techniques, from a plurality of signals transmitted by SPS satellites 102.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Furthermore, the disclosed method and apparatus may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals”, as used herein, is intended to include SPS-like signals from pseudolites or equivalents of pseudolites.

When deriving position from the WWAN, each WAN-WAPs 104a-104c may take the form of base stations within a digital cellular network, and the mobile station 108 may include a cellular transceiver and processor that can exploit the base station signals to derive position. It should be understood that a digital cellular network may include additional base stations or other resources shown in FIG. 1. While WAN-WAPs 104 may actually be moveable or otherwise capable of being relocated, for illustration purposes it will be assumed that they are essentially arranged in a fixed position.

The mobile station 108 may perform position determination using known time-of-arrival techniques such as, for example, Advanced Forward Link Trilateration (AFLT). In other embodiments, each WAN-WAP 104a-104c may take the form of a WiMAX wireless networking base station. In this case, the mobile station 108 may determine its position using time-of-arrival (TOA) techniques from signals provided by the WAN-WAPs 104. The mobile station 108 may determine positions either in a stand-alone mode, or using the assistance of a back end server 110 and a network 112 using conventional techniques. Note that embodiments of the disclosure may include having the mobile station 108 determine position information using WAN-WAPs 104 which are different types. For example, some WAN-WAPs 104 may be cellular base stations, and other WAN-WAPs may be WiMAX base stations. In such an operating environment, the mobile station 108 may be able to exploit the signals from each different type of WAN-WAP, and further combine the derived position solutions to improve accuracy.

When deriving position using the WLAN, the mobile station 108 may utilize time of arrival techniques with the assistance of the positioning server 110 and the network 112. The positioning server 110 may communicate to the mobile station 108 through network 112. Network 112 may include a combination of wired and wireless networks which incorporate the LAN-WAPs 106. In one embodiment, each LAN-WAP 106a-106e can be, for example, a Wi-Fi wireless access point or a femtocell, thus not necessarily set in a fixed position and can change location. The position of each LAN-WAP 106a-106e may be stored in the positioning server 110 in a common coordinate system. In one embodiment, the position of the mobile station 108 may be determined by having the mobile station 108 receive signals from each LAN-WAP 106a-106e. Each signal may be associated with its originating LAN-WAP based upon some form of identifying information that may be included in the received signal (such as, for example, a Media Access Control (MAC) address). The mobile station 108 may then form a message which can include the time delays and the identifying information of each of the LAN-WAPs, and send the message via network 112 to the positioning sever 110. Based upon the received message, the positioning server 110 may then determine a position, using the stored locations of the relevant LAN-WAPs 106, of the mobile station 108. The positioning server 110 may generate and provide an Location Configuration Information LCI message to the base station 108 that includes a pointer to the mobile station's position in a local coordinate system. The LCI message may also include other points of interest in relation to the location of the mobile station 108.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

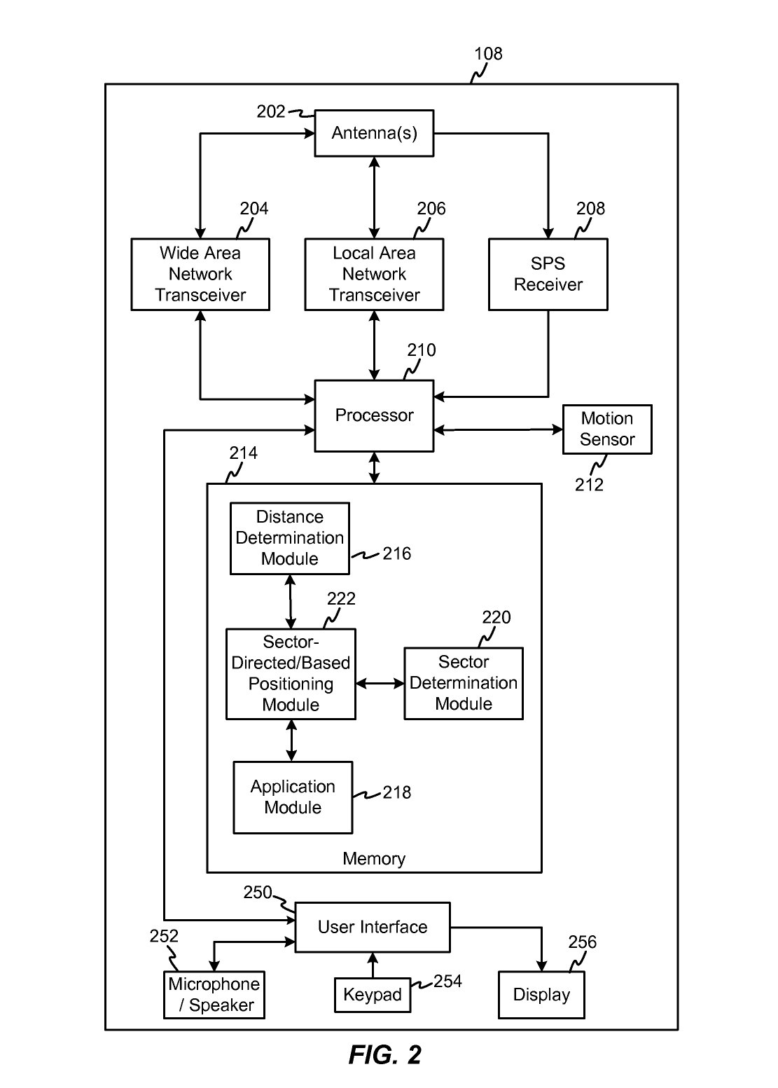

FIG. 2 is a block diagram illustrating various components of an exemplary mobile station 108. For the sake of simplicity, the various features and functions illustrated in the box diagram of FIG. 2 are connected together using a common bus which is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 2 may be further subdivided or two or more of the features or functions illustrated in FIG. 2 may be combined.

The mobile station may include one or more wide area network transceiver(s) 204 that may be connected/coupled to one or more antennas 202. The wide area network transceiver 204 comprises suitable devices, hardware, and/or software for communicating with and/or detecting signals to/from WAN-WAPs 104, and/or directly with other wireless devices within a network. In one aspect, the wide area network transceiver 204 may comprise a CDMA communication system suitable for communicating with a CDMA network of wireless base stations; however in other aspects, the wireless communication system may comprise another type of cellular telephony network, such as, for example, TDMA or GSM. Additionally, any other type of wireless networking technologies may be used, for example, WiMAX (IEEE 802.16), etc. The mobile station 108 may also include one or more local area network transceivers 206 that may be connected/coupled to one or more antennas 202. The local area network transceiver 206 comprises suitable devices, hardware, and/or software for communicating with and/or detecting signals to/from LAN-WAPs 106, and/or directly with other wireless devices within a network. In one aspect, the local area network transceiver 206 may comprise a Wi-Fi (IEEE 802.11x) communication system suitable for communicating with one or more wireless access points; however in other aspects, the local area network transceiver 206 may comprise another type of local area network, personal area network (e.g., Bluetooth), etc. Additionally, any other type of wireless networking technologies may be used, for example, Ultra Wide Band, ZigBee, wireless USB etc.

An SPS receiver 208 may also be included in mobile station 108. The SPS receiver 208 may be connected/coupled to the one or more antennas 202 for receiving satellite signals. The SPS receiver 208 may comprise any suitable hardware and/or software for receiving and processing SPS signals. The SPS receiver 208 requests information and operations as appropriate from the other systems, and performs the calculations necessary to determine the mobile station's 108 position using measurements obtained by any suitable SPS algorithm.

A motion sensor 212 may be coupled to processor 210 to provide movement and/or orientation information which is independent of motion data derived from signals received by the wide area network transceiver 204, the local area network transceiver 206 and the SPS receiver 208. By way of example but not limitation, motion sensor 212 may utilize an accelerometer (e.g., a MEMS device), a gyroscope, a geomagnetic sensor (e.g., a compass), an altimeter (e.g., a barometric pressure altimeter), and/or any other type of movement detection sensor. Moreover, motion sensor 212 may include a plurality of different types of devices and combine their outputs in order to provide motion information.

A processor 210 may be connected/coupled to the wide area network transceiver 204, local area network transceiver 206, the SPS receiver 208 and the motion sensor 212. The processor 210 may include, for example, one or more microprocessors, microcontrollers, controllers, ASICs, and/or digital signal processors that provide processing functions, as well as other calculation and control functionality. The processor 210 may also include memory 214 for storing data and software instructions for executing programmed functionality within the mobile station. The memory 214 may be on-board the processor 210 (e.g., within the same IC package), and/or the memory may be external memory to the processor and functionally coupled over a data bus. The details of software functionality associated with aspects of the disclosure will be discussed in more detail below.

A number of software modules and data tables may reside in memory 214 and be utilized by the processor 210 in order to manage both communications and positioning determination functionality. As illustrated here, within memory 214, the mobile station 108 may include or otherwise provide a distance determination module 216, an application module 218, sector determination module 220, and sector-based positioning module 222.

The application module 218 may be any type of application running on processor 210, and may utilize the position of the mobile station 108 in order to perform some desired functionality. The application module 218 may request this position information from the sector based positioning module 222. The sector based positioning module 222 may in turn receive distance information to wireless access points from distance determination module 216, and sector information from sector determination module 220. Moreover, the sector based positioning module 222 may receive additional information from the motion sensor 212 and/or SPS receiver 208 to refine position. The sector based positioning module 222 may also obtain the coordinates of each wireless access point (either via the distance determination module 216 or some other source). Once the information is received, the sector based positioning module 222 may determine the position of the mobile station 108 and provide it back to the application module 218.

The distance determination module 216 may derive a distance estimate between each wireless access point with which the mobile station 108 can wirelessly exchange signals. The distance estimates may be performed using conventional ranging techniques based upon signal timing and/or signal strength. The distance determination module 216 may further derive information from signals exchanged with the wide area network transceiver 204, the local area network transceiver 206 and/or SPS receiver 208. Moreover, distance information may also be generated by processing data provided by the motion sensor 212. Each of these sources may be used separately and/or combined using processor 210 in accordance with the distance determination module 216. In certain implementations, all or part of the information may also be provided by way of motion sensor 212 and/or SPS receiver 208 without further processing by processor 210. In some embodiments, the distance information may be directly provided by the motion sensor 212 to the processor 210. Data supplied by motion sensor 212 may also include acceleration data and/or velocity data which may provide direction and speed. Additional data may further include directionality data which may only provide direction of movement. Once the distance determination module 216 ascertains the distances to one or more wireless access points, it may provide these distances to the sector based positioning module.

The sector determination module 220 may process information provided by wireless access points to identify sub-regions within the area of coverage called sectors. The sectors may be defined/described in a variety of ways in which the sector determination module may interpret (as will be described in detail below), and then convert this information into coordinates describing the sectors in a common reference frame for use by the sector based positioning module 222.

Upon receiving the wireless access point coordinates, the distance estimates, and the sector information, the sector based processing module 222 can process these data to provide a position estimate of the mobile station 108 using processor 210. In another embodiment, the distance estimates and the sector information may be passed to the back-end server 110 (e.g., over the Internet or WAN) for processing.

While the modules shown in FIG. 2 are illustrated in the example as being contained in memory 214, it is recognized that in certain implementations such procedures may be provided for or otherwise operatively arranged using other or additional mechanisms. For example, all or part of the sector directed/based positioning module 222, the distance determination module 216, the application module 218 and/or sector determination module 220 may be provided in firmware. Additionally, while in this example sector based positioning module 222 and application module 218 are illustrated as being separate features, it is recognized, for example, that such procedures may be combined together as one procedure or perhaps with other procedures, or otherwise further divided into a plurality of procedures.

Processor 210 may include any form of logic suitable for performing at least the techniques provided herein. For example, processor 210 may be operatively configurable based on instructions in memory 214 to selectively initiate one or more routines that exploit motion data for use in other portions of the mobile device.

The mobile station 108 may include a user interface 250 which provides any suitable interface systems, such as a microphone/speaker 252, keypad 254, and/or display 256 that allows user interaction with the mobile station 108. The microphone/speaker 252 may provide for voice communication services using the wide area network transceiver 204 and/or the local area network transceiver 206. The keypad 254 may comprise any suitable buttons for user input. The display 256 may comprise any suitable display, such as, for example, a backlit LCD display, and may further include a touch screen display for additional user input modes.

As used herein, mobile station 108 may be any portable or movable device or machine that is configurable to acquire wireless signals transmitted from, and transmit wireless signals to, one or more wireless communication devices or networks. As shown in FIGS. 1 and 2, the mobile station 108 is representative of such a portable wireless device. Thus, by way of example but not limitation, mobile station 108 may include a radio device, a cellular telephone device, a computing device, a personal communication system (PCS) device, a Personal Information Manager (PIM), a Personal Digital Assistant (PDA), a laptop, a smartbook, a network, or other or other suitable mobile device which, for example, may be capable of receiving wireless communication and/or navigation signals. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. “Mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above is also considered a “mobile station.”

As used herein, the term “wireless device” may refer to any type of wireless communication device which may transfer information over a network and also have position determination and/or navigation functionality. The wireless device may be any cellular mobile terminal, personal communication system (PCS) device, personal navigation device, laptop, personal digital assistant, or any other suitable mobile device capable of receiving and processing network and/or SPS signals.

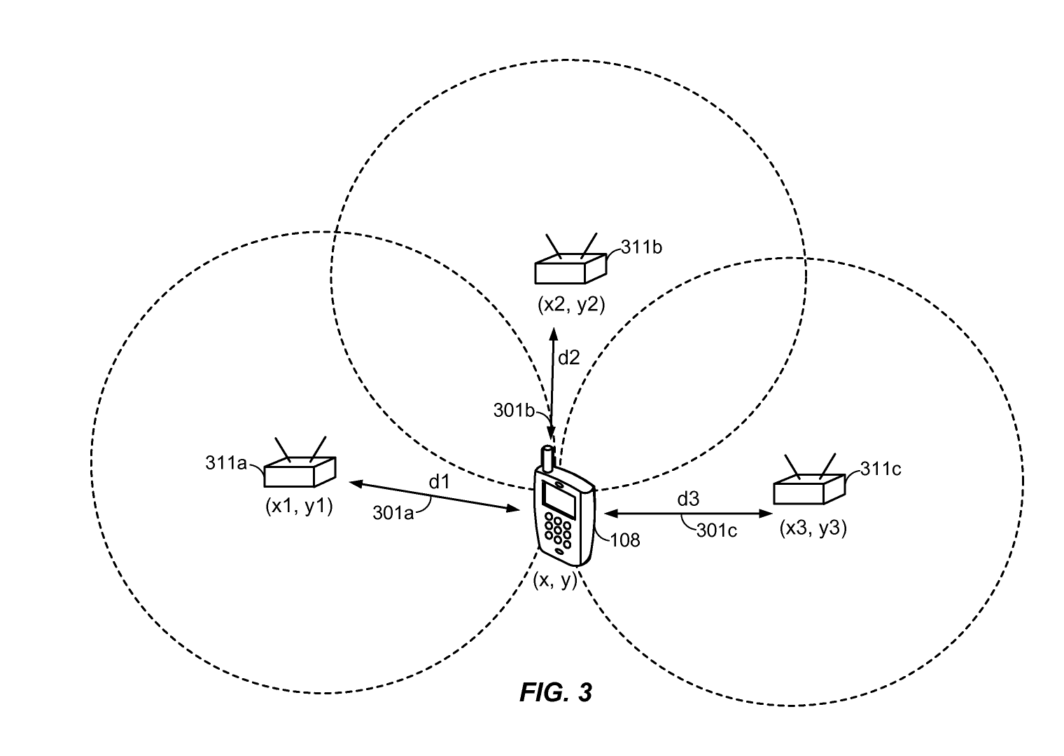

FIG. 3 is a drawing illustrating an exemplary network geometry defined by a mobile station and a number of access points within wireless range of the mobile station 108. For ease of explanation and illustration, the embodiments herein are described in terms of two-dimensional position techniques. However, one should appreciate that the invention is not so limited, and that the embodiments described herein may easily extend to determining positions in three dimensional space. Moreover, while the embodiments presented below utilize communications with Local Area Network Wireless Access Points (LAN-WAPs), other types of wireless access points may be used. For example, other embodiments may exploit communications with Wide Area Network Wireless Access Points (WAN-WAPs), and/or a combination of LAN-WAPs and WAN-WAPs.

As shown in FIG. 3, the mobile station 108 may communicate with one or more LAN-WAPs 311. For example, mobile station 108 may be positioned at location (x, y) and may communicate with LAN-WAP 311a, LAN-WAP 311b, LAN-WAP 311c via wireless links 301a, 301b, and 301c, respectively. While this exemplary embodiment illustrates three LAN-WAPs, it is understood that this is merely exemplary and any number of LAN-WAPs and/or wireless links may be utilized.

LAN-WAP1 311a may be positioned at location (x1, y1); LAN-WAP2 311b may be positioned at location (x2, y2); and LAN-WAP3 311c may be positioned at location (x3, y3). The mobile station 108 may measure the distance to each of the plurality of LAN-WAPs utilizing conventional ranging techniques, for example, approaches which may exploit signal strength and/or time-of-flight. Accordingly, in the scenario provided in FIG. 3, the mobile station 108 may wirelessly measure the distance d1 from LAN-WAP1 311a, the distance d2 from LAN-WAP2 311b, and the distance d3 from LAN-WAP3 311c, utilizing one or more of the conventional ranging techniques.

Further referring to FIG. 3, each of the plurality of LAN-WAPs 311 may include one or more conventional antennas that yield omni-directional antenna patterns. Further, conventional ranging systems like that utilized by each of the LAN-WAPs and mobile station 108 may use omni-directional beacons and packet exchanges. Additionally, each LAN-WAP may include software and/or hardware to utilize appropriate signal processing for performing beamforming using two or more omni-directional antennas. Using beamforming techniques, the antenna patterns from each omni-directional antenna may be coherently combined to perform electronic steering of the combined antenna pattern. In this manner, the aforementioned sectors may be selectively illuminated by the combined antenna pattern. Moreover, the LAN-WAP antennas and additional signal processing may also be used to determine the angle of arrival of a received signal, using conventional angle of arrival techniques. A mobile station, for example, may transmit a signal for estimating an angle of arrival at the WAP and receive sector information from the WAP derived from the estimated angle of arrival.

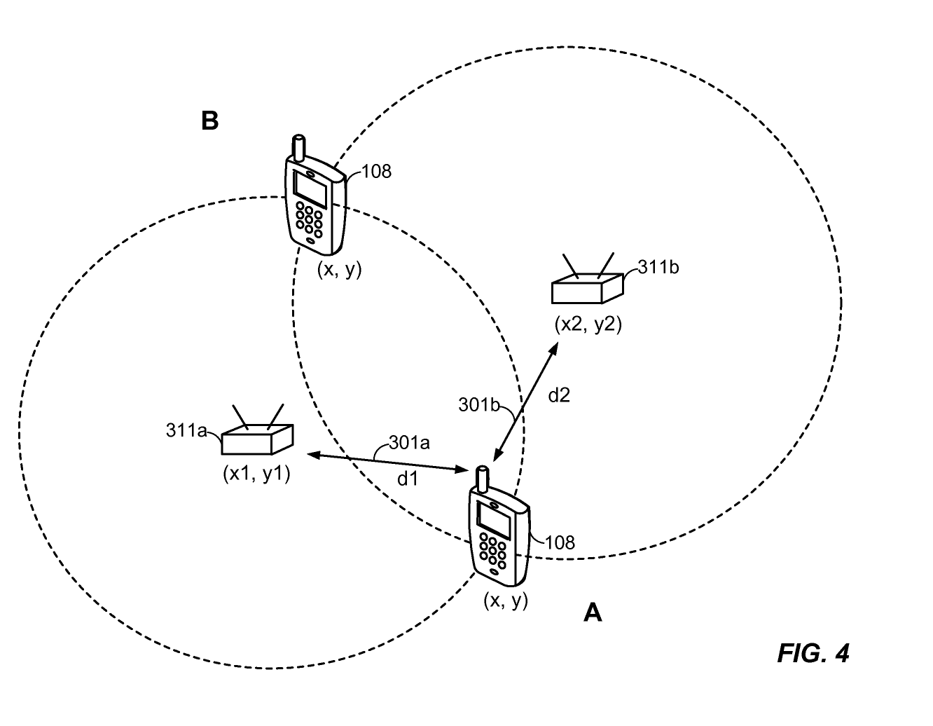

FIG. 4 is a drawing illustrating another exemplary network geometry where a positioning ambiguity may arise if only two LAN-WAPs are used to determine position. FIG. 4 illustrates a similar network geometry that was shown above in FIG. 3, however in this scenario, the LAN-WAP 311c is no longer communicating with mobile station 108. This may, for example, be due to the presence of noise and/or other factors. However, mobile station 108 may communicate with LAN-WAPs 311a and 311b. Further referring to FIG. 4, mobile station 108 may measure the distance d1 from LAN-WAP1 311a and the distance d2 from LAN-WAP2 311b utilizing conventional ranging techniques. Because only two LAN-WAPs are available, the mobile station's ability to unambiguously determine its location may be impaired when using conventional positioning approaches. For example, when using trilateration techniques, mobile station 108 could be located at either Position A or Position B. Therefore, without the assistance of additional information, conventional triangulation techniques may result in inaccurate or ambiguous results. As will be described below, embodiments of the disclosure may exploit additional information so that the aforementioned ambiguities may be resolved, algorithm efficiency may be improved, and/or the overall positioning accuracy may be increased.

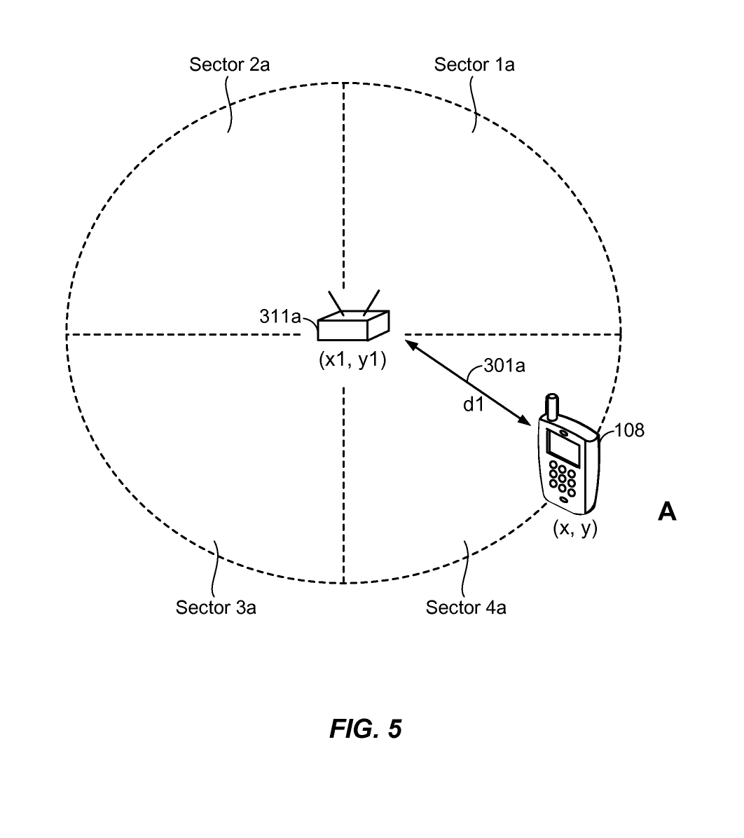

FIG. 5 is a drawing illustrating sector-directed position determination consistent with an exemplary embodiment of the disclosure. As before, a two-dimensional geometry is shown for ease of description, however this is not limiting as it should be appreciated that embodiments may readily extend to three dimensional geometries.

As described above, in a conventional position-determination system, once each of the distances have been determined, the position (x, y) of the mobile station 108 may be computed using trilateration. However, by having the mobile station exploit additional information that may be provided by each of the LAN-WAPs, embodiments of the disclosure may improve position determination. These improvements may be brought about by dividing the network geometry into sub-spaces called sectors. The sectors may be areas and/or volumes, and can be designated in a variety of ways which will be described in more detail below. The sectors may be defined in two-dimensions and/or three dimensions, depending upon whether 2-D or 3-D positioning is being performed. Once it is determined that the mobile station's position is bounded within a particular sector, the information which defines the bounding sector can be used to supplement conventional positioning algorithms (e.g., trilateration) to improve accuracy and/or performance of position determination. Ascertaining position by exploiting sector information is defined herein as sector-directed position determination.

LAN-WAP 311a may contain multiple antennas (N) which can employed to electronically steer a combined (e.g., synthesized) antenna pattern to selectively illuminate a sector of interest. In some embodiments, the number of antennas may be four (e.g., N=4), however, the number of antennas can take on any value within practical limits. Electronic steering may be performed using conventional beamforming techniques. For example, when transmitting, the LAN-WAP 311 can control the phase and amplitude of the signal at each antenna in order to create a pattern of constructive and destructive interference in the wavefront produced by all of the antennas. The amplitude and phase at each antenna may be controlled by applying a set of weights to the signal prior to transmission from each antenna, wherein the weights may take the form of complex valued coefficients. When receiving, the signals received by the antennas may first be weighted by a set of coefficients, and then combined, so the combined receive antenna pattern has similar directivity as the transmitted antenna pattern (e.g., the receive pattern is steered over the same sector of interest as the transmit pattern). While the set of coefficients used for transmission and reception may be the same, in alternative embodiments, they could be different to compensate known phase and/or amplitude errors. The weighting coefficients may be quickly changed to steer the transmit/receive patterns to scan different sectors in a round robin manner, or, if desired, illuminate sectors in any arbitrary manner. While each of the plurality of LAN-WAPs 311 may pre-store a set of weighting coefficients, it should be understood that the weighting coefficients may be changed over the network to alter the patterns and/or scanning approach as desired.

Further referring to FIG. 5, utilizing N antennas, the LAN-WAP 311 may form N sectors of approximately 360/N degrees. In other words, the LAN-WAP 311 may partition its coverage area into N approximately distinct sectors when transmitting or receiving packets. For example, LAN-WAP 311a may contain four antennas, which may result in four sectors (sectors 1a-sector 4a) taking the form of four quadrants.

It should be noted that the steering of the transmit/receive patterns need not be limited to 360/N increments. For example, if desired, the amplitude and/or phasing between the antennas may be varied to steer the beam over any arbitrary angle. Moreover, it also follows that the sector coverage need not be symmetric about the LAN-WAP, and that the sectors could take on any arbitrary shape. For example, if a LAN-WAP is placed at a corner of a room, it may be beneficial to restrict the sectors to span the interior space within the room so that energy is more efficiently directed to the areas of interest, and also so that security can be improved because access to the LAN-WAP via the exterior may be prevented.

During operation, each of the LAN-WAPs 311 may transmit a signal having a beacon to each sector. The transmission sequence may take place in a round-robin manner, or may be performed in any pre-defined sequence. Further, each of the LAN-WAPs 311 may send sector information in the beacon signal thus providing additional information to the mobile station 108. This sector information may be any type of data which uniquely identifies each sector within the network geometry to the mobile station 108, and could include coordinate information, angular information (one or more planar angle such as azimuth and/or elevation), a unique integer, etc. For example, in the embodiment shown in FIG. 5, the sectors may be divided into four quadrants, and can be described in a local 2-D coordinate system. Using the exemplary 2-D local system, Sector 1a may be defined as the sector having x>x1 and y>y1, Sector 2a may be defined as the sector having x<x1 and y>y1, Sector 3a may be defined as the sector having x<x1 and y<y1, and Sector 4a may be defined as the sector having x>x1 and y<y1.

In some embodiments, the sector information may be predefined in advance and stored in the LAN-WAP. In other embodiments, the sector information may be determined by having the LAN-WAP estimate the angle of arrival of a packet sent by the mobile station 108. The angle of arrival may be determined by the LAN-WAP using its multiple antennas and its signal processing capability using known techniques. In other embodiments, the sector data may be provided over a different network (e.g., a network external to the LAN) other than the LAN-WAPs themselves, such as, for example the Internet and/or the WAN. In such embodiments, the sector data may be provided by the back end server 110.

Regarding the mobile station 108, in some embodiments, it may only utilize one antenna given the cost and space constraints typically associated with a mobile device. Accordingly, the mobile station may transmit and receive based upon the pattern resulting from its real antenna, and thus may not perform beamforming. However, in other embodiments, a more sophisticated mobile station may take advantage of beamforming for electronic steering depending upon the mobile station's antenna configuration and signal processing capability. In such an embodiment, the mobile station having multiple antennas could perform angle-of-arrival detection to estimate the direction of a beacon/packet from LAN-WAP.

Finally, it should be noted that embodiment shown in FIG. 5 only shows sector designations having two-dimensions for ease of illustration and explanation, one should realize that the sector definitions and/or antenna scanning may extend to three dimensions if desired.

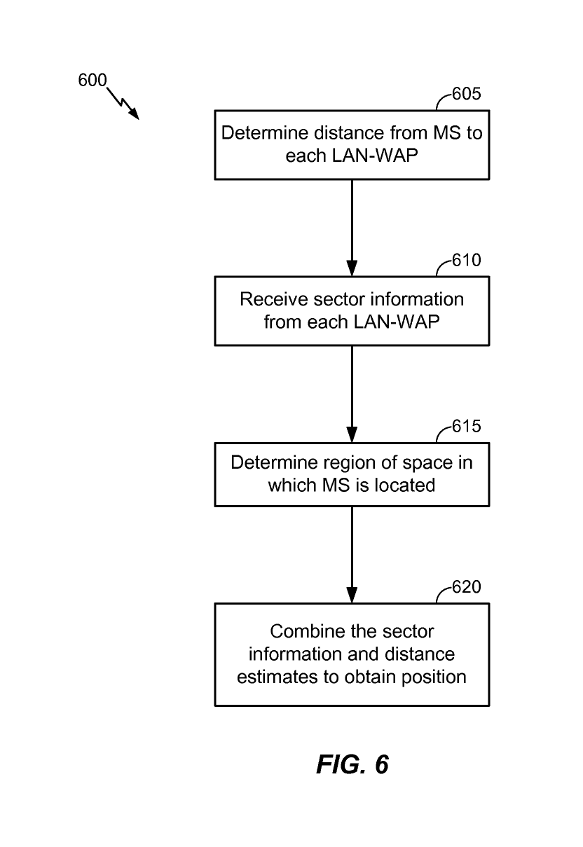

FIG. 6 is a flowchart 600 illustrating an exemplary sector-directed position determination algorithm. Referring to FIG. 6, an exemplary position determination algorithm that can be implemented on the mobile station 108.

Initially, the mobile station 108 can determine distance(s) to one or more LAN-WAPs 311 which are within radio range of the mobile station (Block 605). The distance determination may be performed by processor 210 using distance determination module 216, and can utilize any known techniques as mentioned above. Next, the mobile station 108 may receive and decode beacons that may contain additional information which identifies the sectors associated with the beacon transmission (Block 610). In more detail, each beacon packet may contain information identifying the sector, which may include various types of information as mentioned above. The sector information may then be further processed in the sector determination module 220 so that the mobile station 108 knows the sector in which it resides in a reference frame it can use (Block 615). For example, if the sector identification is provided as an integer, the integer may be used to determine/describe the coordinates defining the geometric boundaries of the sector in a standard coordinate system. In another embodiment, the sector information may be provided in a local coordinate system/local reference frame which is referenced to the LAN-WAP, and the local coordinates may be transformed to a common reference coordinate system/common reference frame prior to being provided to the sector based positioning module 222. Once the distance(s) to each LAN-WAP and the sector in which the mobile station resides is identified, the processor 210 may combine this information to determine the position of the mobile station 108 (Block 620).

In some embodiments, the mobile station will receive sector information from two or more LAN-WAPs, each of which may divide their respective coverage area into sectors. The mobile station may further resolve common areas covered by two or more overlapping sectors to more narrowly bound its position, and subsequently improve the accurately and/or efficiency of its position determination. The mobile station 108 may compare such combinations of sector(s) in the sector based positioning module 222. The comparison may be used to determine which combinations of sectors are valid. For example, in one embodiment, data contained within the sector based positioning module 222 may include a database, a table of valid sector combinations, or any other form of mapping or association of valid sector combinations. In other embodiments, the mobile station, for example, may determine whether a set of sectors received is valid (e.g., valid sector combinations) based on their coordinates, and/or by dynamically computing whether a set of sectors received is valid, and/or based on what the most likely position is based on the distance estimates and sector information.

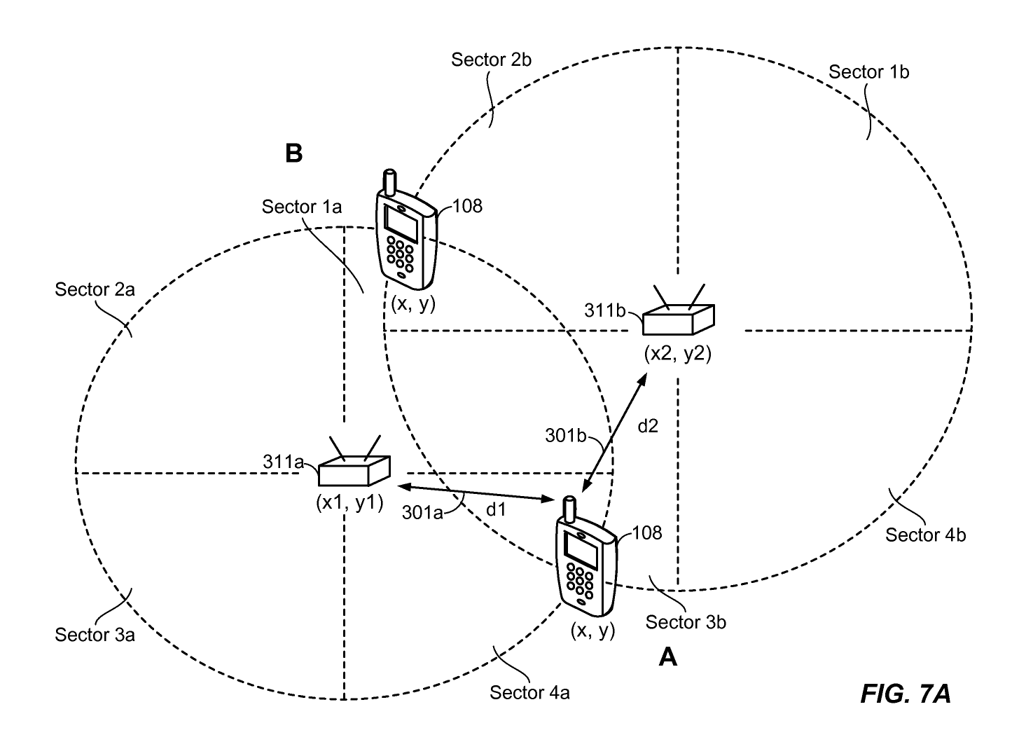

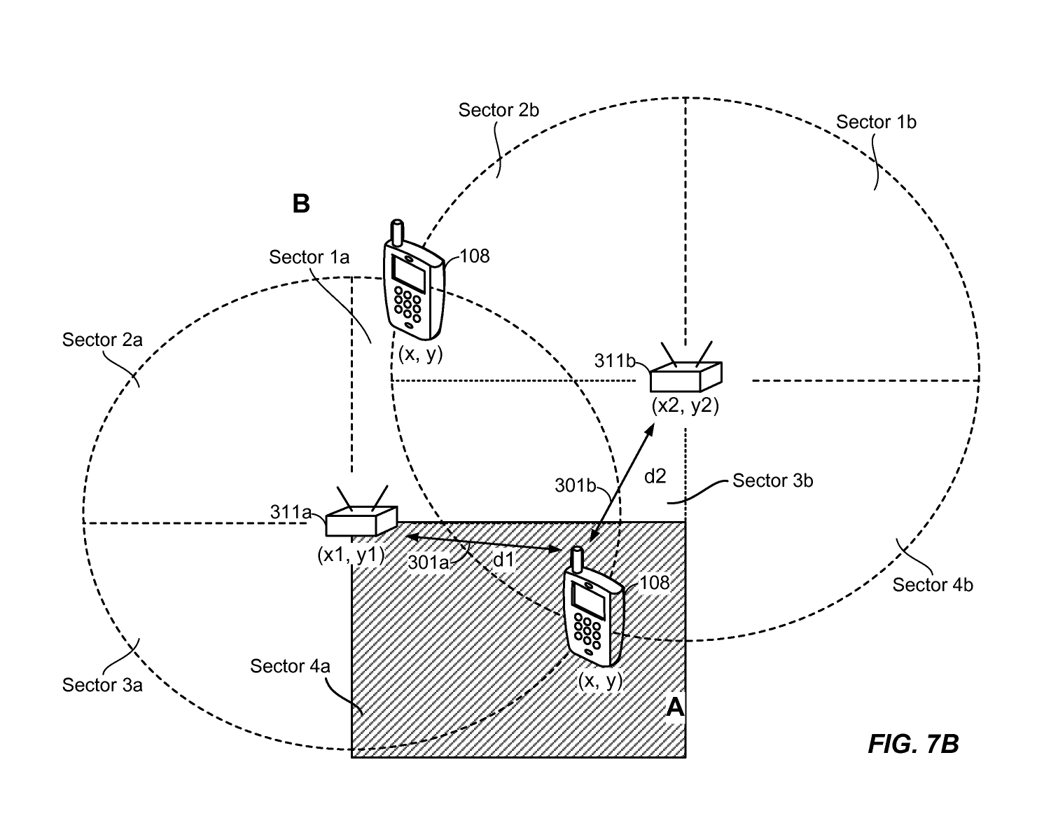

As shown in FIGS. 7A and 7B, the sector information may also be used to resolve position ambiguities when they occur. Here, two LAN-WAPs 311a, 311b may have divided their area of coverage into sectored regions, and mobile station 108 may communicate with the LAN-WAPs 311a and 311b in a manner as previously described above in the description of FIG. 4. However, the LAN-WAP 311c may no longer be communicating with mobile station 108 due, for example, to the presence of noise and/or other factors.

Mobile station 108 may measure the distance d1 from LAN-WAP1 311a and mobile station 108 may measure the distance d2 from LAN-WAP2 311b utilizing conventional ranging techniques. However, when utilizing conventional positioning techniques, the mobile station's 108 may not be able to unambiguously determine its position. For example, using conventional triangulation techniques, mobile station 108 could be located at either Position A or Position B. In this exemplary embodiment, mobile station 108 may unambiguously determine its location by exploiting the sector information when performing position determination as described above in FIG. 6. For example, LAN-WAP 311a and LAN-WAP 311b may each contain four antennas, which may result in four sectors, each extending over 90 degrees. The area covered by LAN-WAP 311a can be divided into sectors 1a-4a; and the area covered by the LAN-WAP 311b can be divided into sectors 1b-4b.

FIG. 7B further illustrates how the ambiguity of the mobile station's position may be resolved by exploiting the intersection of sectors from the two LAN-WAPs 311a, 311b. In this scenario, each of the LAN-WAPs 311 may send a beacon to each sector in a round-robin manner. The beacon signal may include sector information that informs the mobile station 108 of the sectors in which it is located with respect to each LAN-WAP. The mobile station 108 may receive these beacon signal from each of the LAN-WAPs 311 and more efficiently and/or accurately perform position determination given the narrow area in which the mobile station has been bounded. In the example of FIG. 7B, if just one of LAN-WAPs 311a and 311b divides its area of coverage into sectored regions, mobile station 108 may still unambiguously determine its position (e.g., MS 108 may determine from sector information received from 311a or 311b that MS 108 is located in sector 4a or 3b, respectively, and can eliminate Position B as a possible location because Position B is outside a relevant sector).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methodologies described herein may be implemented by various means depending upon the application. For example, these methodologies may be implemented in hardware, firmware, software, or any combination thereof. For a hardware implementation, the processors/processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor/processing unit. Memory may be implemented within the processor/processing unit or external to the processor/processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), hard disk, floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors/processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Accordingly, an embodiment of the invention can include a computer readable media embodying a method for determining an estimate of a distance between the mobile station and at least one wireless access point (WAP), receiving sector information which describes sectors associated with the WAP, and combining the distance estimate and sector information to determine a position of the mobile station. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of determining a position of a mobile station, comprising:
determining an estimate of a distance between the mobile station and at least one wireless access point (WAP);
receiving sector information which describes sectors associated with the at least one WAP; and
combining the distance estimate and sector information to determine a position of the mobile station.

2. The method according to claim 1, further comprising:
determining a geometric description of the sector in which the mobile resides from the sector information.

3. The method according to claim 1, wherein the sector information includes a number of sectors and an index, a value defining the angular extent of the sector, and/or coordinates defining the region which is associated with the sector.

4. The method according to 3, wherein the coordinates are in a local reference frame associated with the at least one WAP, and further comprising:
transforming the coordinates in the local reference frame into a common reference frame.

5. The method according to claim 1, further comprising:
receiving the sector information from beacons signals transmitted by the at least one WAP.

6. The method according to 5, further comprising:
receiving beacon signals providing information associated with a plurality of sectors, wherein each beacon signal is transmitted in a round-robin manner.

7. The method according to claim 1, further comprising:
receiving the sector information from a back end server through an external network.

8. The method according to claim 1, further comprising:
receiving sector information from a plurality of WAPs, wherein the sector information from each WAP is uniquely associated therewith; and
determining whether sector combinations received from the plurality of WAPs are valid.

9. The method according to claim 8, wherein determining whether the sector combinations are valid comprises:
computing dynamically whether a set of sectors received is valid based upon their coordinates and/or what the most likely position is based on the distance estimates and sector information.

10. The method according to claim 1, further comprising:
transmitting a signal for estimating an angle of arrival at the at least one WAP; and
receiving sector information from the at least one WAP derived from the estimated angle of arrival.

11. An apparatus for determining position using sectors, comprising:
a wireless transceiver;
a processor coupled to the wireless transceiver; and
a memory coupled to the processor, wherein the memory stores executable instructions and data for causing the processor to:
determine an estimate of a distance between a mobile station and at least one wireless access point (WAP),
receive sector information which describes sectors associated with the at least one WAP, and
combine the distance estimate and sector information to determine a position of the mobile station.

12. The apparatus according to claim 11, wherein the memory includes instructions further causing the processor to:
determine a geometric description of the sector in which the mobile resides from the sector information.

13. The apparatus according to claim 11, wherein the sector information includes a number of sectors and an index, a value defining the angular extent of the sector, and/or coordinates defining the region which is associated with the sector.

14. The apparatus according to 13, wherein the coordinates are in a local reference frame associated with the at least one WAP, and wherein the memory includes instructions further causing the processor to:
transform the coordinates in the local reference frame into a common reference frame.

15. The apparatus according to claim 11, wherein the memory includes instructions further causing the processor to:
receive the sector information from beacons signals transmitted by the at least one WAP.

16. The apparatus according to 15, wherein the memory includes instructions further causing the processor to:
receive beacon signals providing information associated with a plurality of sectors, wherein each beacon signal is transmitted in a round-robin manner.

17. The apparatus according to claim 11, wherein the memory includes instructions further causing the processor to:
receive the sector information from a back end server through an external network.

18. The apparatus according to claim 11, wherein the memory includes instructions further causing the processor to:
receive sector information from a plurality of WAPs, wherein the sector information from each WAP is uniquely associated therewith; and
determine whether sector combinations received from the plurality of WAPs are valid.

19. The apparatus according to claim 18, wherein the instructions causing the processor to determine whether the sector combinations are valid includes instructions causing the processor to:
compute dynamically whether a set of sectors received is valid based upon their coordinates and/or what the most likely position is based on the distance estimates and sector information.

20. The apparatus according to claim 11, wherein the memory includes instructions further causing the processor to:
transmit a signal for estimating an angle of arrival at the at least one WAP; and
receive sector information from the at least one WAP derived from the estimated angle of arrival.

21. An apparatus for determining position using sectors, comprising:
means for determining an estimate of a distance between a mobile station and at least one wireless access point (WAP);
means for receiving sector information which describes sectors associated with the at least one WAP; and
means for combining the distance estimate and sector information to determine a position of the mobile station.

22. The apparatus according to claim 21, further comprising:
means for determining a geometric description of the sector in which the mobile resides from the sector information.

23. The apparatus according to claim 21, wherein the sector information includes a number of sectors and an index, a value defining the angular extent of the sector, and/or coordinates defining the region which is associated with the sector.

24. The apparatus according to 23, wherein the coordinates are in a local reference frame associated with the at least one WAP, and further comprising:
means for transforming the coordinates in the local reference frame into a common reference frame.

25. The apparatus according to claim 21, further comprising:
means for receiving the sector information from beacons signals transmitted by the at least one WAP.

26. The apparatus according to 25, further comprising:
means for receiving beacon signals providing information associated with a plurality of sectors, wherein each beacon signal is transmitted in a round-robin manner.

27. The apparatus according to claim 21, further comprising:
means for receiving the sector information from a back end server through an external network.

28. The apparatus according to claim 21, further comprising:
means for receiving sector information from a plurality of WAPs, wherein the sector information from each WAP is uniquely associated therewith; and
means for determining whether sector combinations received from the plurality of WAPs are valid.

29. The apparatus according to claim 28, wherein the means for determining whether the sector combinations are valid further comprises:
means for computing dynamically whether a set of sectors received is valid based upon their coordinates and/or what the most likely position is based on the distance estimates and sector information.

30. The apparatus according to claim 21, further comprising:
means for transmitting a signal for estimating an angle of arrival at the at least one WAP; and
means for receiving sector information from the at least one WAP derived from the estimated angle of arrival.

31. A machine-readable medium comprising instructions, which, when executed by a machine, cause the machine to perform operations, the instructions comprising:
instructions to determine an estimate of a distance between a mobile station and at least one wireless access point (WAP);
instructions to receive sector information which describes sectors associated with the at least one WAP; and
instructions to combine the distance estimate and sector information to determine a position of the mobile station.

32. The machine-readable medium according to claim 31, further comprising:
instructions to determine a geometric description of the sector in which the mobile resides from the sector information.

33. The machine-readable medium according to claim 31, wherein the sector information includes a number of sectors and an index, a value defining the angular extent of the sector, and/or coordinates defining the region which is associated with the sector.

34. The machine-readable medium according to 33, wherein the coordinates are in a local reference frame associated with the at least one WAP, and further comprising:
instructions to transform the coordinates in the local reference frame into a common reference frame.

35. The machine-readable medium according to claim 31, further comprising:
instructions to receive the sector information from beacons signals transmitted by the at least one WAP.

36. The machine-readable medium according to 35, further comprising:
instructions to receive beacon signals providing information associated with a plurality of sectors, wherein each beacon signal is transmitted in a round-robin manner.

37. The machine-readable medium according to claim 31, further comprising:
instructions to receive the sector information from a back end server through an external network.

38. The machine-readable medium according to claim 31, further comprising:
instructions to receive sector information from a plurality of WAPs, wherein the sector information from each WAP is uniquely associated therewith; and
instructions to determine whether sector combinations received from the plurality of WAPs are valid.

39. The machine-readable medium according to claim 38, wherein the instructions to determine whether the sector combinations are valid comprises:
instructions to compute dynamically whether a set of sectors received is valid based upon their coordinates and/or what the most likely position is based on the distance estimates and sector information.

40. The machine-readable medium according to claim 31, further comprising:
instructions to transmit a signal for estimating an angle of arrival at the at least one WAP; and
instructions to receive sector information from the at least one WAP derived from the estimated angle of arrival.

41. The method of claim 1, wherein the at least one WAP includes a femtocell.

42. The apparatus of claim 11, wherein the at least one WAP includes a femtocell.
